(19) United States
(12) Patent Application Publication
(10) Pub. No.: US 2020/0245637 A1
(43) Pub. Date: Aug. 6, 2020

(54) FOOD COMPOSITIONS CONTAINING REDUCED-FLAVOR COCOA PRODUCT AS BULK FILLER

(71) Applicant: THE HERSHEY COMPANY, Hershey, PA (US)

(72) Inventor: James F. ST. JOHN, Hummelstown, PA (US)

(21) Appl. No.: 16/645,117

(22) PCT Filed: Aug. 31, 2018
(86) PCT No.: PCT/US18/49207

§ 371 Date: Mar. 6, 2020

Related U.S. Application Data
(60) Provisional application No. 62/553,272, filed on Sep. 1, 2017.

(51) Int. Cl. A23G 1/40; A23G 1/00; A23G 1/46

(52) U.S. Cl. CPC A23G 1/40; A23G 1/46; A23G 1/0036

(57) ABSTRACT

A method of forming a food product includes substituting a pre-determined amount of added sugar of the food product with a bulk filler including a reduced-flavor cocoa product. The formed food product includes the bulk filler. A method of forming a milk chocolate composition includes mixing and grinding a cocoa composition including sugar, a milk powder, and a reduced-flavor cocoa product and conching the cocoa composition with a fat composition including cocoa butter to form the milk chocolate composition. A confectionery composition includes sugar, at least one fat source, and a bulk filler including a reduced-flavor cocoa product.

### CROSS-REFERENCE TO RELATED APPLICATIONS

This application claims priority to and the benefit of U.S. Provisional Application No. 62/553,272, filed Sep. 1, 2017, which is hereby incorporated by reference in its entirety.

### FIELD OF THE INVENTION

This application is directed to food compositions and more particularly to food compositions in which a reduced-flavor cocoa product is used as a bulk filler, such as, for example, to reduce sugar content and/or caloric content in confections.

### BACKGROUND OF THE INVENTION

Consumer perceptions of sugar have resulted in some consumers desiring products containing reduced levels of added sugars in confections and other products. Milk chocolates typically have approximately 50% or more by weight of sugars, while dark chocolates may have up to 40% or more by weight of sugars. While various sugar replacers have been introduced, they have been met with different levels of success. Many sugar replacers, such as, for example, sugar alcohols and/or fibers, have some type of drawback, such as, for example, high price, the potential for gastro-intestinal (GI) problems in some individuals, and/or flavor/textural deficiencies that make them less desirable. Thus, while some consumers may desire reduced added sugar levels, those consumers also generally find current alternative low sugar chocolates and confectioneries unsatisfactory in light of one or more of these issues.

Furthermore, milk and dark chocolates with these sugar replacers do not meet the “Standard of Identity” requirements in many countries. As a result, such confections cannot be labeled as “milk chocolate” or “dark chocolate” in those countries because the sugar replacers are not allowed in standardized chocolates.

### BRIEF DESCRIPTION OF THE INVENTION

In an exemplary embodiment, a method of forming a food product includes substituting a pre-determined amount of added sugar of the food product with a bulk filler including a reduced-flavor cocoa product. The formed food product includes the bulk filler.

In another exemplary embodiment, a method of forming a milk chocolate composition includes mixing and grinding a cocoa composition including sugar, a milk powder, and a reduced-flavor cocoa product and conching the cocoa composition with a fat composition including cocoa butter to form the milk chocolate composition.

In another exemplary embodiment, a confectionery composition includes sugar, at least one fat source, and a bulk filler including a reduced-flavor cocoa product.

Exemplary embodiments are directed to providing a sugar replacer that overcomes some or all of the drawbacks in current reduced-sugar confections to produce a food product that does not suffer from taste issues, texture issues, GI issues, cost issues, label issues, or a combination of such issues.

Exemplary embodiments employ de-flavored and preferably defatted cocoa as a sugar replacer and/or bulk filler to replace some added sugar content in confections and other food products. Among the advantages of exemplary embodiments is that the use of cocoa results in the presence of a sugar substitute that still falls within the standard of identity for chocolate.

Other features and advantages of the present invention will be apparent from the following more detailed description of exemplary embodiments, which illustrate, by way of example, the principles of the invention.

### DETAILED DESCRIPTION OF EXEMPLARY EMBODIMENTS

In exemplary embodiments, a portion of added sugar in a food composition is substituted by a bulk filler that includes a reduced-flavor cocoa product. The food composition is preferably not more bitter and preferably does not have a stronger taste as a result of the replacement. The bulk filler may reduce the caloric content of the food composition. The bulk filler, including the reduced-flavor cocoa product, preferably meets “Standard of Identity” requirements for the food product. The reduced-flavor cocoa product may be a reduced-flavor cocoa powder, a de-flavored cocoa powder, a reduced-flavor non-fat cocoa, or a de-flavored non-fat cocoa. In exemplary embodiments, the food composition is a milk chocolate or a dark chocolate. In some embodiments, a reduced-flavor cocoa product serves as a filler in a non-chocolate composition.

As used herein, the term “substituting” refers to altering a reference formulation to replace at least a portion of a substituent of the reference formulation with a second substituent and forming a food composition from the altered formulation. In exemplary embodiments, the substituent of the reference formulation is sugar. In exemplary embodiments, the second substituent is a bulk filler. The substituting may provide a food composition with a reduced sugar content and/or a reduced caloric content relative to a reference composition from the reference formulation. The substituting may otherwise provide a food composition with a similar texture and/or a similar taste profile to a reference composition from the reference formulation.

Cocoa powder results from pressing cocoa butter out of unsweetened chocolate (also referred to as chocolate liquor). Cocoa powder, by federal regulations in the United States, must contain between 10% and 12% cocoa butter, while completely defatted cocoa is labeled as “non-fat cocoa”. Cocoa powder has a caloric content of approximately 2.1 kcal/gram (as measured by the Atwater method) which is significantly less than the caloric content of sugar (4 kcal/gram) and fats (9 kcal/gram). Completely defatted cocoa powder has only 1.4 kcal/gram (Atwater).

As a result, using cocoa in place of sugar reduces the caloric content of confections or other food products. Unfortunately, however, cocoa has a very strong chocolate flavor and is very bitter. Methylxanthines, primarily caffeine and theobromine, naturally present in cocoa significantly contribute to this strong/bitter flavor. An unsweetened chocolate typically includes about 1.3% theobromine and about 0.2% caffeine, by weight. A natural cocoa powder typically includes about 2.5% theobromine and about 0.5% caffeine, by weight. A de-flavored cocoa powder may have less than 0.00001% theobromine and caffeine, by weight. A reduced-flavor cocoa powder may have less than 0.5% theobromine and less than 0.1% caffeine, by weight, such as, for example, less than 0.1% theobromine and less than 0.02% caffeine, by weight.

Typical milk chocolate has approximately 5% to 8% non-fat cocoa solids. The added sugar in milk chocolate acts, in part, as a bitterness inhibitor. In addition to sweetening, the added sugar also acts as a bulk filler. A milk chocolate with higher levels of full-flavor non-fat cocoa and less sugar is too bitter and too high in chocolate flavor.

Exemplary embodiments include a reduced-flavor cocoa product to make the cocoa product an acceptable sugar replacer and/or bulk filler for purposes of taste, while also reducing sugar and total calories. By replacing 10%, 15%, 20%, 25%, 30%, or more by weight of the sugar content or added sugar content with reduced-flavor cocoa product, the caloric content of a typical chocolate bar confection is reduced. For example, for a chocolate confection in which the total added sugar content is reduced from 50% to 40% by weight and replaced with 10% by weight de-flavored, non-fat cocoa content, the caloric content decreases from about 205 calories per 40 grams to about 195 calories per 40 grams.

Once separated from the cocoa butter by pressing, the cocoa powder may be reduced in flavor and bitterness by any suitable method that reduces flavor compounds from the cocoa powder and thus mitigates against bitterness by removing flavor. In some embodiments, the pressed cocoa powder is defatted prior to or after flavor reduction so that the end product is a reduced-flavor non-fat cocoa or a de-flavored non-fat cocoa.

In some embodiments, the cocoa or cocoa powder is subject to an extraction technique to remove the flavor compounds. This may include contacting the cocoa or cocoa powder with water, alcohol, or a combination of water and alcohol, followed by drying the wet cocoa or cocoa powder promptly after the extraction process is complete. This helps avoid the possibility of mold or other bacterial growth that might otherwise occur if organic matter is left wet for long, extended periods.

Extraction may be carried out on natural cocoa powder after pressing out the cocoa butter (and optionally followed by defatting to a non-fat cocoa). Alternatively, extraction may be carried out on alkalized, also known as “Dutch,” cocoa following the alkalization process. In some embodiments, the extraction of flavor compounds may be carried out contemporaneously with the alkalization process. Dutching reduces the flavor and bitterness of cocoa powder and the combination of non-alkalized extraction and alkalized extraction may provide a cocoa with an even weaker flavor and even less bitterness. In exemplary embodiments, none of the extract is added back to the cocoa.

In some embodiments, only some of the theobromine and caffeine is removed from the cocoa. In some embodiments, the amount of theobromine and caffeine removed is selected based on the total amount of cocoa to be included in the chocolate composition. In some embodiments, the amount of theobromine and caffeine in the cocoa is selected to provide total amounts of theobromine and caffeine similar to the amounts in a conventional chocolate composition.

In exemplary embodiments, a process of forming a milk chocolate composition includes mixing and grinding a cocoa composition comprising sugar, a milk powder, and a reduced-flavor cocoa product. The method further includes conching the cocoa composition with a fat composition comprising cocoa butter to form the milk chocolate composition.

In exemplary embodiments, the chocolate composition has a reduced sugar content with a similar taste (which may include a similar sweetness) as a conventional chocolate composition, while still being classified as a “Standard of Identity” chocolate.

### EXAMPLES

The invention is further described in the context of the following examples which are presented by way of illustration, not of limitation.

### Comparative Example 1

A typical milk chocolate was formulated according to Table 1. The chocolate liquor included the equivalent of about 6.6% of non-fat cocoa, by weight, of the milk chocolate formulation. The sugar in the whole milk powder was lactose.

TABLE 1
Comparative Example Ingredients

| | | Sugar | Non-fat cocoa |
|---|---|---|---|
| Ingredient | wt % | wt % | wt % |
| Sugar (sucrose) | 50.0 | 50.0 | |
| Cocoa butter | 16.0 | | |
| Chocolate liquor | 14.0 | | 6.6 |
| Whole milk powder | 16.0 | 5.6 | |
| Milk fat, Emulsifier, Flavoring, Lactose | 4.0 | 1.7 | |

### Inventive Example 1

A milk chocolate in accordance with an exemplary embodiment had the formula shown in Table 2, in which about 20% by weight of the added sugar (and 10% of the total composition) of Comparative Example 1 was replaced by de-flavored, non-fat cocoa. The total wt % of non-fat cocoa in the composition was about 16.6% by weight when considering the percentage of non-fat cocoa present in its natural combined form as part of the chocolate liquor.

TABLE 2
Milk Chocolate composition

| | | Sugar | Non-fat cocoa |
|---|---|---|---|
| Ingredient | wt % | wt % | wt % |
| Sugar (sucrose) | 40.0 | 40.0 | |
| Cocoa butter | 16.0 | | |
| Chocolate liquor | 14.0 | | 6.6 |
| Whole milk powder | 16.0 | 5.6 | |
| Milk fat, Emulsifier, Flavoring, Lactose | 4.0 | 1.7 | |
| De-flavored, non-fat cocoa | 10.0 | | 10.0 |

Inventive Example 1 had a total methylxanthine level that was not significantly higher than the total methylxanthine level of Comparative Example 1 and was found to have substantially the same bitterness level as Comparative Example 1 in a descriptive sensory analysis.

### Inventive Example 2

A milk chocolate in accordance with another exemplary embodiment had the formula shown in Table 3. Again, the formula provided for about a 20% reduction in the amount of added sugar relative to Comparative Example 1, with the resulting bulk loss accounted for by the introduction of de-flavored, non-fat cocoa.

TABLE 3
Milk Chocolate composition

| | | Sugar | Non-fat cocoa |
|---|---|---|---|
| Ingredient | wt % | wt % | wt % |
| Sugar (sucrose) | 40.0 | 40.0 | |
| Cocoa butter | 18.0 | | |
| Chocolate liquor | 10.0 | | 4.7 |
| Whole milk powder | 16.0 | 5.6 | |
| Milk Fat, Emulsifier, Flavoring, Lactose | 4.0 | 1.7 | |
| De-flavored, non-fat cocoa | 12.0 | | 12.0 |

It will be appreciated that other formulations could be successfully executed depending on the desired amount of sugar reduction, as well as the relative amounts of cocoa butter and chocolate liquor in addition to the amount of reduced-flavor cocoa powder, reduced-flavor non-fat cocoa, de-flavored cocoa powder, and/or de-flavored non-fat cocoa.

The chocolates made in accordance with exemplary embodiments could be used in any application for which a traditional chocolate might be employed and may be particularly suitable for coating or enrobing applications.

While primarily described herein with respect to chocolate and other confections, it will be appreciated that the principles are not so limited and that reduced-flavor cocoa powder and/or reduced-flavor non-fat cocoa could be used to replace some or all of the added sugar in any food product.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of forming a food product, the method comprising:
substituting a pre-determined amount of added sugar of the food product with a bulk filler comprising a reduced-flavor cocoa product;
wherein the formed food product comprises the bulk filler.

2. The method of claim 1, wherein the reduced-flavor cocoa product comprises a reduced-flavor cocoa powder.

3. The method of claim 1, wherein the reduced-flavor cocoa product comprises a de-flavored cocoa powder.

4. The method of claim 1, wherein the reduced-flavor cocoa product comprises a reduced-flavor non-fat cocoa.

5. The method of claim 1, wherein the reduced-flavor cocoa product comprises a de-flavored non-fat cocoa.

6. The method of claim 1, wherein the bulk filler substitutes for at least 20%, by weight, of the added sugar.

7. The method of claim 1, wherein the reduced-flavor cocoa product includes less than 0.5% theobromine and less than 0.1% caffeine, by weight.

8. The method of claim 1, wherein the food product is a reduced-sugar milk chocolate.

9. A food product formed by the method of claim 1.

10. A process of forming a milk chocolate composition, the process comprising:
mixing and grinding a cocoa composition comprising sugar, a milk powder, and a reduced-flavor cocoa product; and
conching the cocoa composition with a fat composition comprising cocoa butter to form the milk chocolate composition.

11. The process of claim 10, wherein the reduced-flavor cocoa product is selected from the group consisting of a reduced-flavor cocoa powder, a de-flavored cocoa powder, a reduced-flavor non-fat cocoa, a de-flavored non-fat cocoa, and combinations thereof.

12. The process of claim 10, wherein the reduced-flavor cocoa product includes less than 0.5% theobromine and less than 0.1% caffeine, by weight.

13. The process of claim 10, wherein the bulk filler is at least 20%, by weight, of a total weight of the bulk filler and the added sugar.

14. A confectionery composition of a formulation comprising:
sugar;
at least one fat source; and
a bulk filler comprising a reduced-flavor cocoa product.

15. The confectionery composition of claim 14, wherein the reduced-flavor cocoa product is selected from the group consisting of a reduced-flavor cocoa powder, a de-flavored cocoa powder, a reduced-flavor non-fat cocoa, a de-flavored non-fat cocoa, and combinations thereof.

16. The confectionery composition of claim 14, wherein the reduced-flavor cocoa product includes less than 0.5% theobromine and less than 0.1% caffeine, by weight.

17. The confectionery composition of claim 14, wherein the bulk filler is at least 20%, by weight, of a total weight of the bulk filler and the sugar.

18. The confectionery composition of claim 14, wherein the at least one fat source comprises cocoa butter.

19. The confectionery composition of claim 14, wherein the formulation further comprises a milk powder.

20. The confectionery composition of claim 14, wherein the confectionery composition is a reduced-sugar milk chocolate composition.
